(19) United States
(12) Patent Application Publication
(10) Pub. No.: US 2012/0004436 A1
(43) Pub. Date: Jan. 5, 2012

(54) PROCESS FOR THE SYNTHESIS OF 1,3-BIS(AMINOALKYL)DISILOXANES

(75) Inventors: Elke Fritz-Langhals, Ottobrunn (DE); Juergen Stohrer, Pullach (DE)

(73) Assignee: WACKER CHEMIE AG, Muenchen (DE)

(21) Appl. No.: 13/256,740

(22) PCT Filed: Mar. 11, 2010
(86) PCT No.: PCT/EP2010/053099

§ 371 Date: Sep. 15, 2011

(30) Foreign Application Priority Data
Mar. 23, 2009 (DE) 10 2009 001 758.5

(51) Int. Cl. C07F 7/10

(52) U.S. Cl. 556/425

(57) ABSTRACT

The invention provides a process for the synthesis of bis(aminoalkyl)disiloxanes of the general formula I by reaction of the carbamatosilanes of the general formula Ma or of the carbamatodisiloxanes of the general formula Mb or of mixtures thereof in the presence of water, where R¹ is a divalent hydrocarbon radical having 1 to 100 C atoms, it being possible for the carbon chain to be interrupted by non-adjacent oxygens, sulphur atoms, —NR⁶—(CO)— or —NHCONH- groups and for the hydrogens in the divalent hydrocarbon radical individually to be substituted by F, Cl, NR⁷R⁸ or OR⁹ groups, and R², R³, R⁴, R⁵, R⁶, R⁷, R⁸ and R⁹ are hydrocarbon radicals having 1 to 100 C atoms.

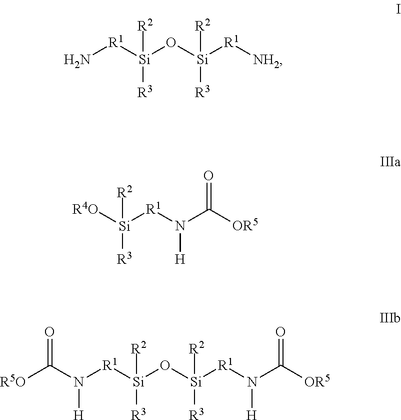

The invention relates to the preparation of bis(aminoalkyl)disiloxanes from the corresponding carbamates by heating with water.

Bis(aminoalkyl)disiloxanes are important intermediates in industry. Reaction with α, ω-dihydroxypolysiloxanes or with cyclic siloxanes by ring opening is a simple way of preparing α, ω-aminoalkylpolysiloxanes. These find application in the synthesis of polyamides, polyurethanes and polyimides for example. α, ω-Amino-alkylpolysiloxanes are also used for enhancing the hydrophobicity and softness of textiles.

Hitherto no process has been found for obtaining bis(aminoalkyl)disiloxanes in a simple manner in high purities.

DE 10049183 describes the synthesis of bis(aminopropyl)tetramethyldisiloxane by hydrolysis of the so-called azacycle, which in turn is prepared by reacting 3-chloropropyldimethylchlorosilane with ammonia under high pressure. This process critically requires a high excess of ammonia under high pressure, since otherwise secondary and tertiary amino groups or quaternary ammonium salts can form. These circumstances add appreciably to the cost of synthesizing bis(aminopropyl)tetramethyldisiloxane.

EP 342518 describes a further way to obtain bis(aminopropyl)tetramethyldisiloxane, viz., the hydro-silylation of allylamine in the presence of specific platinum catalysts at above 100° C., which is inconvenient to implement on an industrial scale because of the low boiling point, the high volatility and the low flashpoint of allylamine.

A further problem with using allylamine is its high toxicity, which likewise militates against use on an industrial scale. Other noble metal-catalyzed hydrosilylations have been performed on N,N-bis(trialkylsilyl)allylamines (U.S. Pat. No. 6,087,520), N-trialkyl-silylamines (Speier, J. Org. Chem. 1959, 24, 119) or allylimines (JP63275591). The need for N-protection before the hydrosilylation and the detachment of the N-protecting groups after the reaction has taken place make these processes inconvenient and costly.

U.S. Pat. No. 4,631,346 describes the reaction of chlorosilanes (H—Si(R₂)—Cl) with toxic allylamine, the further reaction thereof with CO₂ and subsequent hydrosilylation to form otherwise unspecified, presumably oligomeric compounds with structural elements Si—O—CO—NH—(R)—Si, which can be converted with water into the bis(aminoalkyl)disiloxanes. This cleavage reaction is based on the known, extremely easy cleavability of bonds between silicon and acyl radicals. Preparing the oligomeric compounds is industrially very costly and inconvenient.

In a few specific cases, siloxane-containing amines have been prepared by thermal decomposition from carbamates without the action of water. Arimitsu et al., J. Photopolymer Sci. and Technol. 2005, 18, 227; 2002, 15, 41 describe the thermolysis of thermolabile carbamatodisiloxanes with nitropentanyl and fluorenyl radicals to form aminoalkyldisiloxanes.

A paper by Kung et al. (J. Am. Chem. Soc. 2006, 128, 2776) describes the release of amino groups in siloxane-containing nanoparticles from the corresponding BOC—(=tert-butoxycarbonyl) protected precursors with trimethyliodosilane.

A silicate has been used as an example to describe the hydrolytic as well as thermal conversion of a BOC-protected amino group into the corresponding free amino group (A. Mehdi, New J. Chem. 2005, 29, 965). However, the BOC-protected precursor is in turn only obtainable from the free amine itself and hence this does not constitute a route to aminoalkylsiloxanes. BOC-protected amines are not preparable from inexpensive starting materials, for example haloalkanes. In addition, the silicate described is an essentially inorganic solid with specific features, for example high thermal stability and insolubility. The conversion only takes place in the cavities of this solid material and not in solution.

The invention provides a process for synthesis of bis(aminoalkyl)disiloxanes of the general formula I

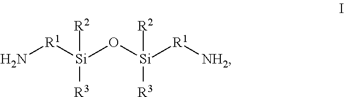

which comprises reacting the carbamatosilanes of the general formula IIIa or the carbamatodisiloxanes of the general formula IIIb or mixtures thereof

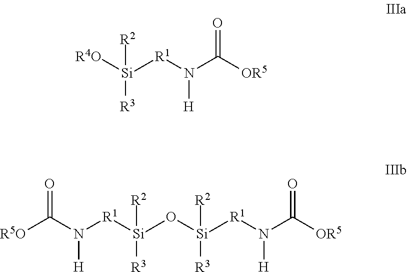

in the presence of water, where
R¹ denotes a divalent hydrocarbon radical of 1 to 100 carbon atoms, wherein the carbon chain may be interrupted by nonadjacent oxygens, sulfur atoms, —NR⁶—(CO) or —NHCONH— groups and the hydrogens of the divalent hydrocarbon radical may individually be replaced by F, Cl, NR⁷R⁸ or OR⁹ groups, and R², R³, R⁴, R⁵, R⁶, R⁷, R⁸ and R⁹ are hydrocarbon radicals of 1 to 100 carbon atoms.

The process is inexpensive, simple and highly selective for the bis(aminoalkyl)disiloxanes of the general formula (I).

R¹ may be more particularly a divalent linear or branched alkyl, cycloalkyl, alkenyl, aryl or aralkyl radical. R¹ is preferably a linear divalent alkyl radical of 1-20 carbon atoms. R¹ is more preferably a methylene, ethylene, propylene, butylene, pentylene or hexylene radical.

R², R³, R⁴, R⁵, R⁶, R⁷, R⁸ and R⁹ may more particularly be linear or branched alkyl, cycloalkyl, aryl, alkenyl or arylalkyl radicals. Preferably, the radicals R², R³, R⁴, R⁵, R⁶, R7, R⁸ and R⁹ have 1-20 and more particularly 1 to 6 carbon atoms. Examples of R², R³, R⁴, R⁵, R⁶, R⁷, R⁸ and R⁹ radicals are alkyl radicals such as methyl, ethyl, n-propyl, isopropyl, n-butyl, isobutyl, n-pentyl, isopentyl or neopentyl, hexyl radicals, such as n-hexyl, heptyl radicals, such as n-heptyl, octyl radicals, such as n-octyl, isooctyl radicals, nonyl radicals, such as n-nonyl, decyl radicals, such as n-decyl; alkenyl radicals such as vinyl and allyl; cycloalkyl radicals such as cyclopentyl, cyclohexyl and cycloheptyl; aryl radicals such as phenyl, naphthyl, o-tolyl, m-tolyl or p-tolyl.

Methyl and ethyl are particularly preferred R⁴ and R⁵ radicals. The process for synthesis of bis(aminoalkyl)disiloxanes of the general formula I is preferably carried out at temperatures of at least 30° C., more preferably at least 70° C. and more particularly at least 90° C. and preferably at most 300° C., more preferably at most 250° C. and more particularly at most 200° C.

The reaction time involved in forming the bis(aminoalkyl)disiloxanes of the general formula I is preferably at least 0.5 hours and more particularly at least 1 hour and preferably at most 30 hours and more particularly at most 15 hours.

The pressure involved in forming the bis(aminoalkyl)disiloxanes of the general formula I is preferably at least 0.05 bar and more particularly at least 0.1 bar and preferably at most 200 bar, more preferably at most 100 bar and more particularly at most 50 bar.

The process is preferably conducted in the presence of at least 10 mol %, more preferably at least 50 mol % and more particularly at least 100 mol % of water and preferably at most 5000 mol % and more particularly at most 1500 mol % of water, all based on the sum total of the carbamato groups and methoxy groups in the carbamatosilanes of the general formula IIIa or the carbamato groups in the carbamatodisiloxanes of the general formula IIIb.

The reaction can take place in any desired solvents and solvent mixtures, preferably in proportions of at least 1% by weight and more particularly at least 10% by weight and preferably at most 99% by weight and more particularly at most 90% by weight, all based on the weight of the entire reaction mixture.

Preference is given to organic solvents that are miscible with water at the reaction temperature in a ratio of 1:10 or 10:1 at least. Examples thereof are tetrahydrofuran, dioxane, DMSO, N-methylpyrrolidone, alcohols or acetonitrile.

The solvents used are preferably mono- or polyhydric alcohols or mixtures of various mono- or polyhydric alcohols. Preference is given to using primary or secondary mono- or polyhydric alcohols. Typical examples of the alcohols added are methanol, ethanol, propanol, butanol, ethylene glycol, propylene glycol, ethylene glycol monomethyl ether, ethylene glycol diethyl ether, glycerol or diethylene glycol.

The reaction is preferably carried out by addition of catalysts preferably in proportions of at least 0.1 mol % and more particularly at least 10 mol % and preferably at most 500 mol % and more particularly at most 300 mol %, all based on the employed carbamatosilane of the general formula IIIa or the carbamatodisiloxane of the general formula IIIb.

Acids or bases are preferred catalysts.

Preferred acids are mineral acids, for example halohydric acids such as, for example, hydrochloric acid, sulfuric acid or phosphoric acid, or acids comprising organic radicals, more particularly organic sulfonic acids, for example methanesulfonic acid or p-toluenesulfonic acid.

Preferred bases are inorganic metal hydroxides, more particularly alkali metal and alkaline earth metal hydroxides, and sodium hydroxide and potassium hydroxide are particularly preferred bases.

In one particular embodiment, specifically suitable for compounds of the general formulae IIIa and IIIb where R⁵ is tert-alkyl, the conversion to compounds of the general formulae Ia and Ib can also take place in the absence of water with or without addition of an acidic catalyst, more preferably with addition of an acid in proportions of preferably at least 0.01 mol % and more particularly at least 0.1 mol % and preferably at most 20 mol % and more particularly at most 10 mol %, all based on the employed carbamatosilane of the general formula IIIa or the carbamatodisiloxane of the general formula IIIb.

The preparation of bis(aminoalkyl)disiloxanes of the general formula I from the carbamatosilane of the general formula IIIa or the carbamatodisiloxane of the general formula IIIb in the presence of water according to the invention may lead to the by-production of silanols of the general formula Ia, which form an equilibrium with the bis(aminoalkyl)disiloxanes of the general formula I that is dependent on the concentration, the temperature, the water content and the catalyst content. Converting the silanols of the general formula Ia into the disiloxanes of the general formula I is readily possible by removal of water, for example by fractional distillation, and likewise forms part of the subject matter of the present invention.

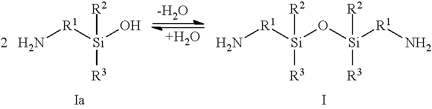

The employed carbamatosilane of the general formula IIIa or the carbamatodisiloxane of the general formula IIIb or mixtures thereof are preferably formed by reacting the silanes of the general formulae IIa or the siloxanes of the general formulae IIb or mixtures thereof

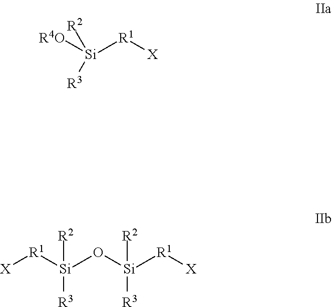

with a cyanate salt of the formula M(OCN)ₘ and an alcohol R⁵OH in a polar solvent, where
X is a halogen atom selected from Cl, Br or I,
M is a metal atom selected from K, Na, Li, Mg, Ca, Fe or Mn, Zn, and
m is 1, 2, 3 or 4,
and R¹, R², R³, R⁴ and R⁵ are each as defined above.
X is preferably a chlorine atom.
M is preferably K or Na.

The cyanate salt of the formula M(OCN)ₘ is preferably employed in proportions of at least 1 equivalent and more particularly at least 1.1 equivalents and preferably at most 5 equivalents and more particularly at most 3 equivalents, all based on the group X.

The alcohol R⁵OH is preferably employed in proportions of at least 1 equivalent and more particularly at least 1.1 equivalents and preferably at most 10 equivalents and more particularly at most 4 equivalents, all based on the group X.

The preparation of carbamatosilane of the general formula IIIa or carbamatodisiloxane of the general formula IIIb is optionally carried out in the presence of a catalyst. Catalysts used are optionally alkali metal iodides or bromides, preferably KI or NaI, or quaternary ammonium or phosphonium salts, for example but not exclusively methyltriphenylphosphonium bromide, methyl-tri-N-butylammonium bromide or methyltrioctyl-ammonium bromide.

The proportion of catalysts is preferably at least 0.01 mol % and more particularly at least 0.1 mol % and preferably at most 10 mol % and more particularly at most 5 mol %, all based on the employed compounds IIa or IIb.

It is preferable for the polar solvents used to be dipolar aprotic solvents such as sulfoxides, for example DMSO, amides, e.g., formamide, N,N-dimethylformamide, N,N-dimethylacetamide or N-methylpyrrolidone, ketones, e.g., acetone or methyl ethyl ketone, nitriles, e.g., acetonitrile, propionitrile or benzonitrile, or esters, e.g., ethyl acetate.

The preparation of the compounds of the general formulae IIIa or IIIb is preferably carried out at temperatures of at least 80° C., more preferably at least 100° C. and more particularly at least 120° C. and preferably at most 200° C., more preferably at most 160° C. and more particularly at most 150° C.

The reaction time involved in forming the compounds of the general formulae IIIa or IIIb is preferably at least 0.5 hours and more particularly at least 1 hour and preferably at most 30 hours and more particularly at most 10 hours.

The reaction can be carried out by mixing the components in any desired order and heating, preferably under agitation. The components can also be mixed at elevated temperature or directly at the reaction temperature.

In one particular embodiment, however, the cyanate salt of the formula M(OCN)ₘ, optionally the catalyst and the polar solvent can also be initially charged and the compounds of the general formulae IIa or IIb added at the reaction temperature in admixture with the alcohol.

In a further particular embodiment, all the components can be initially charged except for the compounds of the general formulae IIa and IIb and these then added at the reaction temperature.

Workup can be carried out in the usual manner known to a person skilled in the art. In one particular embodiment, the solvent is removed by distillation and the residue comprising the product and salts is further reacted directly.

In a further embodiment, the carbamatosilane of the general formula IIIa can be converted into the carbamatodisiloxane of the general formula IIIb before workup, by addition of water. This is advantageous with the use of solvents that have a very high boiling point and therefore are difficult to remove from the carbamatosilane of the general formula IIIa (which, after all, has a lower boiling point than the disiloxane).

The carbamates of the general formulae IIIa and IIIb can be used in isolated form, but also as crude products from the preceding stage of synthesis, viz., the carbamate synthesis. The salts generated in the course of the reaction need not be removed, as described in U.S. Pat. No. 3,494,951 for example, for the preparation of bis(aminoalkyl)disiloxanes of the general formula I.

A preferred embodiment comprises a first step of reacting the compounds of the general formulae IIIa or IIIb or mixtures thereof by reacting the silanes of the general formulae IIa or the siloxanes of the general formulae IIb or mixtures thereof in the manner described above and a second step in which the reaction product is mixed with water and preferably heated to at least 30° C. to produce the synthesis of bis(aminoalkyl)-disiloxanes of the general formula I.

Preferably, the solvent is removed by distillation after the first step and the carbamate-containing solid is directly further reacted in the second step.

Exposing haloalkylhalosilanes to the action of alcohols or water is a very easy and convenient way of forming the haloalkylalkoxysilanes of the general formula IIa and/or the bis(haloalkyl)disiloxanes of the general formula IIb. Since this succeeds even on an industrial scale, the compounds IIa and IIb are very useful starting materials for the compounds of the general formula I. It is further advantageous that compounds of the general formulae IIIa and IIIb only contain halogen atoms attached via an alkyl group, and not additionally the highly reactive Si-halogen groupings, since this counteracts the formation of by-products.

All the above symbols in the above formulae each have their meanings independently of each other. The silicon atom is tetravalent in all the formulae.

All amounts and percentages are by weight, all pressures are 0.10 MPa (abs.) and all temperatures are 20° C. in the examples which follow, unless specifically stated otherwise. MTBE is methyl tertiary butyl ether.

### EXAMPLE 1

27.0 g (74 mmol) of bis(methylcarbamatopropyl)tetra-methyldisiloxane and 91 ml of 20 percent aqueous hydrochloric acid are boiled under reflux for 9 hours, then evaporated in vacuo and admixed with 28.5 ml of 5N NaOH. The aqueous phase is separated off and the organic phase is initially distilled under atmospheric pressure to remove water. Vacuum distillation yields 17 g (92%) of pure bis(aminopropyl)tetramethyl-disiloxane. Boiling point 77° C./4 mbar. Si NMR (D₂O/HC1): δ=17.99 ppm and 10.76 ppm (mixture of disiloxane and silanol).

### EXAMPLE 2

4.00 g (11.0 mmol) of bis(methylcarbamatopropyl)tetra-methyldisiloxane and 4.15 ml of 20 percent aqueous hydrochloric acid are heated to 150° C. in an autoclave where the pressure is limited to 5 bar by releasing the carbon dioxide formed. After 1 hour reaction time the conversion to bis(aminopropyl)tetramethyldisiloxane is 75%.

### EXAMPLE 3

2.00 g (5.49 mmol) of bis(methylcarbamatopropyl)tetra-methyldisiloxane are heated with 14 ml of 2N H₂SO₄ to 100° C. for 16 hours (complete conversion). The reaction mixture is made alkaline with 5M NaOH and extracted with MTBE and the organic phase is evaporated in vacuo. Yield 1.28 g (94%) of bis(aminopropyl)tetra-methyldisiloxane.

### EXAMPLE 4

2.00 g (5.49 mmol) of bis(methylcarbamatopropyl)tetra-methyldisiloxane, 10 ml of 5M NaOH (25 mmol) and 5 ml of methanol are boiled under reflux for 15 hours (complete conversion). The reaction mixture is diluted with water and extracted with MTBE. The organic phase is evaporated to leave 0.95 g (70%) of bis(aminopropyl)tetramethyldisiloxane.

### EXAMPLE 5

2.00 g (5.49 mmol) of bis(methylcarbamatopropyl)tetra-methyldisiloxane, 10 ml of 5M NaOH (25 mmol) and 5 ml of ethanol are boiled under reflux for 15 hours. The workup is carried out similarly to example 4, yield 60%.

### EXAMPLE 6

2.00 g (5.49 mmol) of bis(methylcarbamatopropyl)tetra-methyldisiloxane are heated with 1.52 g (11.0 mmol) of potassium carbonate and 40 ml of water to 140° C. in an autoclave for 4 hours. The reaction mixture is acidified, the organic phase is separated off, the aqueous phase is made alkaline and extracted with dichloromethane, and the extract is evaporated to yield 0.4 g of bis(aminopropyl)tetramethyldisiloxane.

### EXAMPLE 7

A mixture of 20 ml of 1-methyl-2-pyrrolidone, 7.53 g (92.8 mmol) of potassium cyanate and 137 mg (0.83 mmol) of potassium iodide is heated to 145° C. under an inert gas (argon) and admixed at 145° C. with a mixture of 13.6 g (81.6 mmol) of 3-chloropropyldimethylmethoxy-silane and 3.75 ml of methanol added dropwise in the course of 2 hours with stirring, while the temperature is maintained between 140 and 145° C. Stirring is continued at this temperature until conversion is complete (about 4 hours), and the reaction mixture is allowed to cool down and filtered, and the solvent is distilled off in vacuo at 11 mbar. The residue is boiled under reflux with 13 g of 20 percent hydrochloric acid for 8 hours. The reaction mixture is made alkaline with 5N NaOH (pH 11), optionally diluted with a little water to obtain two clear phases, and the aqueous phase is separated off. The organic phase comprises a 1:1 mixture of the silanol Ia and the disiloxane, yield (NMR standard analysis) 80%.

### EXAMPLE 8

A mixture of 60 ml of 1-methyl-2-pyrrolidone, 15.1 g (186 mmol) of potassium cyanate, 3.09 g (18.6 mmol) of potassium iodide, 22.6 g (98.8 percent, 77.7 mmol) of bis(chloropropyl)disiloxane and 7 ml of methanol is heated to 120° C. under agitation and under inert gas (argon), and a further 11 ml of methanol are added at 120° C. during 5 hours. The reaction mixture is allowed to cool down and filtered, and the solvent is distilled off in vacuo at 11 mbar. The residue (24 g) is boiled under reflux with 120 ml of 20 percent hydrochloric acid for 8 hours. The reaction mixture is made alkaline with 5N NaOH (pH 11), optionally diluted with a little water to obtain two clear phases, and the aqueous phase is separated off. The organic phase comprises a mixture of the silanol, the disiloxane and about 20% of water, yield (NMR standard analysis) 50%.

1. A process for synthesis of bis(aminoalkyl)disiloxanes of the general formula I 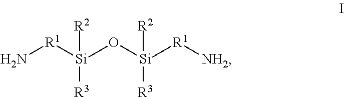
which comprises reacting carbamatosilanes of the general formula IIIa or carbamatodisiloxanes of the general formula IIIb or mixtures thereof 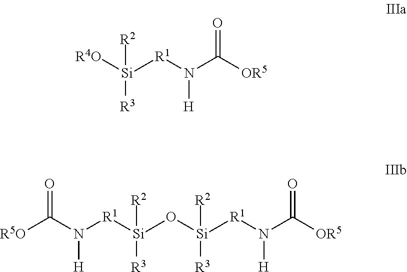
in the presence of water, where
R¹ denotes a divalent hydrocarbon radical of 1 to 100 carbon atoms, wherein a carbon chain thereof is optionally interrupted by nonadjacent oxygens, sulfur atoms, —NR⁶—(CO) or —NHCONH— groups and hydrogens of the divalent hydrocarbon radical are optionally individually replaced by F, Cl, NR⁷R⁸ or OR⁹ groups, and
R², R³, R⁴, R⁵, R⁶, R⁷, R⁸ and R⁹ are hydrocarbon radicals of 1 to 100 carbon atoms.

2. The process according to claim 1 wherein R¹ is a linear divalent alkyl radical of 1-20 carbon atoms.

3. The process according to claim 1 conducted at 30° C. to 300° C.

4. The process according to claim 1 conducted in the presence of 10 mol % to 5000 mol % of water, each based on a sum total of carbamato groups and methoxy groups in the carbamatosilanes of the general formula IIIa or the carbamato groups in the carbamatodisiloxanes of the general formula IIIb.

5. The process according to claim 1 conducted in the presence of acids or bases as catalysts.

6. The process according to claim 1 wherein silanols of the general formula Ia 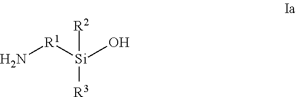
are byproducts and wherein the silanols of the general formula la release water to form the bis(aminoalkyl)disiloxanes of the general formula I.

7. The process according to claim 1 wherein, in a first step, the carbamatosilane of the general formula IIIa or the carbamatodisiloxane of the general formula IIIb or mixtures thereof are formed by reacting silanes of the
general formula IIa or the-siloxanes of the general formula IIb or mixtures thereof 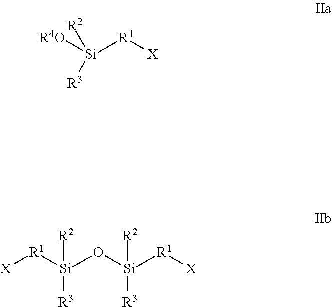
with a cyanate salt of the formula M(OCN)ₘ and an alcohol R⁵OH in a polar solvent to form a reaction product,
where
X is a halogen atom selected from Cl, Br or I,
M is a metal atom selected from K, Na, Li, Mg, Ca, Fe, Mn or Zn, and
m is 1, 2, 3 or 4,
and, in a second step, the reaction product is admixed with water to synthesize the bis(aminoalkyl)disiloxanes of the general formula I.

8. The process according to claim 7 wherein X is a chlorine group.

9. The process according to claim 7 wherein M is K or Na.

10. The process according to claim 2 conducted at 30° C. to 300° C.

11. The process according to claim 10 conducted in the presence of 10 mol % to 5000 mol % of water, each based on a sum total of carbamato groups and methoxy groups in the carbamatosilanes of the general formula IIIa or the carbamato groups in the carbamatodisiloxanes of the general formula IIIb.

12. The process according to claim 11 conducted in the presence of acids or bases as catalysts.

13. The process according to claim 12 wherein silanols of the general formula Ia 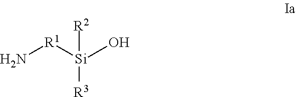
are byproducts and wherein the silanols of the general formula Ia release water to form the bis(aminoalkyl)disiloxanes of the general formula I.

14. The process according to claim 13 wherein, in a first step, the carbamatosilane of the general formula Ma or the carbamatodisiloxane of the general formula IIIb or mixtures thereof are formed by reacting silanes of the general formula IIa or siloxanes of the general formula IIb or mixtures thereof 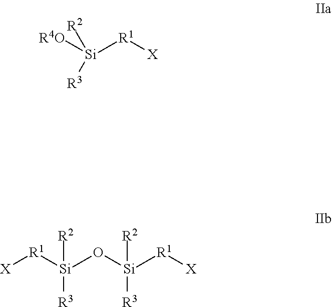
with a cyanate salt of the formula M(OCN)ₘ and an alcohol R⁵OH in a polar solvent to form a reaction product,
where
X is a halogen atom selected from Cl, Br or I,
M is a metal atom selected from K, Na, Li, Mg, Ca, Fe, Mn or Zn, and
m is 1, 2, 3 or 4,
and, in a second step, the reaction product is admixed with water to synthesize the
bis(aminoalkyl)disiloxanes of the general formula I.

15. The process according to claim 14 wherein X is a chlorine group.

16. The process according to claim 15 wherein M is K or Na.
